(19) United States
(12) Patent Application Publication
(10) Pub. No.: US 2014/0125821 A1
(43) Pub. Date: May 8, 2014

(54) SIGNAL PROCESSING CIRCUIT, IMAGING APPARATUS AND PROGRAM

(71) Applicant: Sony Corporation, Tokyo (JP)

(72) Inventors: Seiji Kawa, Kanagawa (JP); Motohiro Nakasuji, Kanagawa (JP); Takeshi Oka, Kanagawa (JP)

(73) Assignee: Sony Corporation, Tokyo (JP)

(21) Appl. No.: 14/063,192

(22) Filed: Oct. 25, 2013

(30) Foreign Application Priority Data
Nov. 2, 2012 (JP) 2012-243012

(51) Int. Cl. H04N 5/232; H04N 9/73

(52) U.S. Cl. CPC H04N 5/23235; H04N 9/735
USPC 348/207.1

(57) ABSTRACT

There is provided a signal processing circuit including a color separation unit, a first development unit, a first resolution conversion unit, a second development unit, and an interface unit.

### CROSS REFERENCE TO RELATED APPLICATIONS

This application claims the benefit of Japanese Priority Patent Application JP 2012-243012 filed Nov. 2, 2012, the entire contents of which are incorporated herein by reference.

### BACKGROUND

The present disclosure relates to a signal processing circuit, an imaging apparatus and a program that are used, for example, for converting the resolution of an image.

Previously, high-definition of an image sensor included in an imaging apparatus enabled a single image sensor to contain many pixels. Each pixel outputs an image signal, and an imaging apparatus adequately processes the image signal. Thereafter, the imaging apparatus saves the image signal to a high-capacity memory, or displays an image on a display device capable of displaying a high-definition image. In memories, a dynamic random access memory (DRAM) that operates synchronously with clock signals is called a synchronous DRAM (SDRAM). In recent years, there have been used a double data rate (DDR) 1, DDR2 and DDR3 whose transfer rates are increased.

Within the imaging apparatus, a variety of software and hardware are used. In order to get the ease of software control in processing of the image signal, it is desirable to exclude interdependencies among processing blocks constituting hardware. To do this, it is thought that a design of a signal processing circuit is simplified by increasing processing blocks that once store the image signal to the memory for each process unit that is a certain set of processes, and thereafter move the image signal from memory to memory as much as possible.

Japanese Patent Laid-Open No. 2006-101389 discloses a technique that generates a first image from raw data in a short time and generates a second image with a high quality from the raw data.

### SUMMARY

In a processing in which an image signal is once stored to a memory and thereafter the image signal is read from the memory, an abuse of a bandwidth consumption in a bus or the like used within an imaging apparatus becomes large remarkably, and it is difficult to configure a signal processing circuit on one chip. For example, when a DDR3 memory having a bandwidth of 1.3 [Gbps] and a bus width of 16 bits can be used at an efficiency of 70%, a bandwidth of 1.3×16×0.7=14.5 [Gbps] can be utilized.

However, for a memory storing or reading processing of data including luminance signals (Y) and color signals (C) at 4:4:2 and 20 bits, which express a 4K image (for example, an image with a resolution of 4096×2160 or 3840×2160), a maximum bandwidth of 12 [Gbps] is required. Thereby, when performing both the processing for storing the data to the memory and the processing for reading the data from the memory, a maximum bandwidth of 12×2=24 [Gbps] is required. This leads to a tightness of the bandwidth of the memory, furthermore, if the memory is used for another processing, it is anticipated that the whole processing is delayed.

In the technique disclosed in Japanese Patent Laid-Open No. 2006-101389, which is used in the case of playing an image with a low resolution, it is difficult to process a 2K image (for example, an image with a resolution of 1920×1080) or the 4K image at a high speed.

Thereby, even if a memory with a broad bandwidth is used, it is desirable to provide an improvement by which a bandwidth to be used for image signals in a signal processing circuit is suppressed as low as possible.

The present disclosure has been made in view of such circumstances, and is intended to perform a processing for efficiently converting the resolution of an image.

According to an embodiment of the present disclosure, an RGB-based s image signal having a first resolution is color-separated from raw data, and a YC-based s image signal is written to a first area in a memory. The YC-based s image signal includes a luminance signal Y and a color signal C that are separated from the RGB-based s image signal.

The RGB-based s image signal is converted into an RGB-based t image signal that has a resolution different from the RGB-based s image signal, and a YC-based t image signal is written to a second area in the memory. The YC-based t image signal includes a luminance signal Y and a color signal C that are separated from the RGB-based t image signal.

Then, an interface unit that is connected to a peripheral device through a transmission line with a predetermined interface standard, performs a reading or a writing of the YC-based s image signal to the first area or performs a reading or a writing of the YC-based t image signal to the second area, and inputs or outputs the YC-based s image signal or the YC-based t image signal to the peripheral device.

Thus, it is possible to decrease the inputting and outputting of an image signal to a memory.

According to the present disclosure, a processing for converting the resolution of an image signal is efficiently performed, and thereby a bandwidth to be used in a memory is not tightened.

### BRIEF DESCRIPTION OF THE DRAWINGS

FIG. 1 is a block diagram showing an exemplary internal configuration of a camcorder according to an exemplary embodiment of the present disclosure;

FIG. 2 is a block diagram showing a flow of a signal processing when recoding an image signal and displaying an image by a method in related art;

FIG. 3 is a block diagram showing a flow of a signal processing when recoding an image signal and displaying an image by a method according to an exemplary embodiment of the present disclosure;

FIG. 4 is a block diagram showing a flow of a signal processing when playing a 4K (YC) image signal by a method in related art;

FIG. 5 is a block diagram showing a flow of a signal processing when playing a 4K (YC) image signal by a method according to an exemplary embodiment of the present disclosure; and

FIG. 6 is a block diagram showing a flow of a signal processing when playing a 2K (YC) image signal by a method according to an exemplary embodiment of the present disclosure.

### DETAILED DESCRIPTION OF THE EMBODIMENT(S)

Embodiments of the present disclosure (hereinafter, referred to as exemplary embodiments) will be described below. Here, descriptions will be made in the following order. Common parts are denoted with the same reference numerals, and detailed descriptions therefor are omitted.

1. Exemplary embodiment (exemplary control of a processing sequence of an image signal)

### 2. Modifications

### 1. Exemplary Embodiment

### Exemplary Control of a Processing Sequence of an Image Signal

Hereinafter, a camcorder 1 according to an exemplary embodiment of the present disclosure will be described with reference to the appended drawings.

With a computer executing a program, this camcorder 1 implements a signal processing method that internal blocks described later perform in cooperation with each other. In this specification and the appended drawings, structural elements that have substantially the same function and structure are denoted with the same reference numerals, and repeated explanation of these structural elements is omitted.

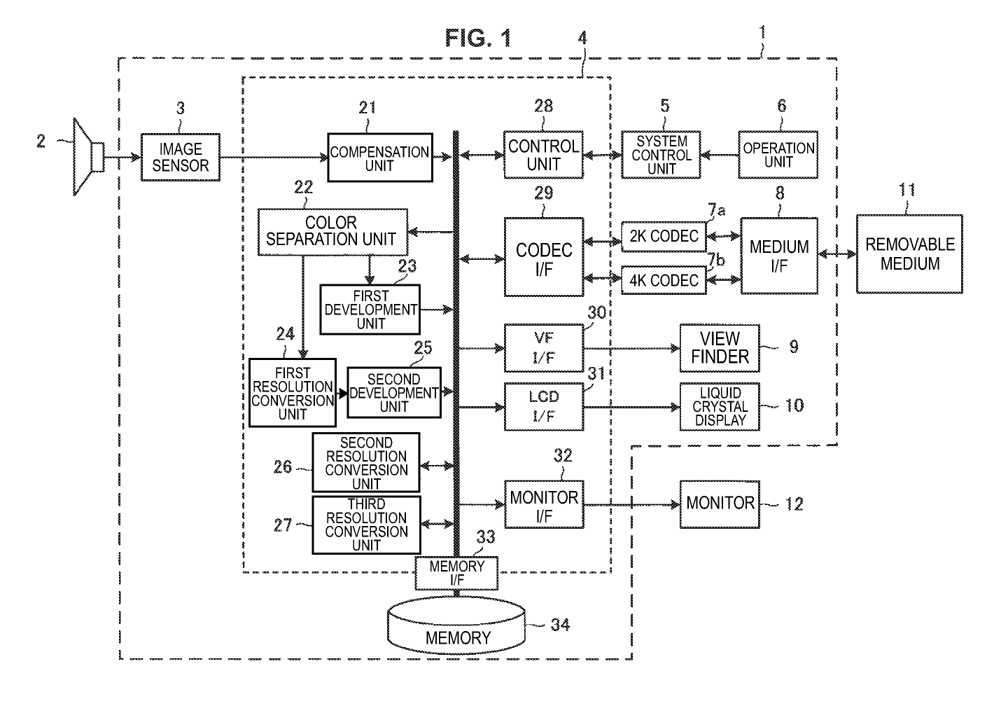

FIG. 1 is a block diagram showing an exemplary internal configuration of the camcorder 1.

The camcorder 1 includes an image sensor 3 to output an image signal of raw data, based on a subject image formed on an imaging surface through an optical system 2 including a lens and the like, and a signal processing circuit 4 to perform a predetermined signal processing to the image signal. The optical system 2 includes a shutter, an iris and the like, which are not shown, and can be appropriately replaced depending on the usage environment of the camcorder 1. The image sensor 3 has, for example, a Bayer array configuration, and outputs raw data composed of image signals for R, G (Gb, Gr) and B, to the signal processing circuit 4.

The camcorder 1 includes a system control unit 5 to control each unit in addition to the signal processing circuit 4, and an operation unit 6 to receive an input by a user operation and to output an operation signal to the system control unit 5. The camcorder 1 includes a codec to encode a 4KYC-based (4:2:2) image signal (hereinafter, referred to as a “4K (YC) image signal”), which is an example of a YC-based s image signal input from an interface unit, and then to output the signal to a removable medium 11. This codec can also encode a 2KYC-based (4:2:2) image signal (hereinafter, referred to as a “2K (YC) image signal”), which is an example of a YC-based t image signal, and then output the signal to the removable medium 11. This codec can also decode the YC-based s image signal (4K (YC) image signal) or YC-based t image signal (2K (YC) image signal) input from the removable medium 11, and then output the signal to the interface unit. Concretely, the camcorder 1 include a 2K codec 7a to perform a codec processing for the 2K (YC) image signal while being involved with a codec interface 29 of the signal processing circuit 4, and a 4K codec 7b to perform a codec processing for the 4K (YC) image signal while being involved with the codec interface 29 of the signal processing circuit 4. In the 2K codec 7a and the 4K codec 7b, for example, AVC codecs are used, and it is possible to encode or decode the image signals.

The camcorder 1 includes a medium interface 8 into which the removable medium 11 is inserted. The medium interface 8 writes the 2K (YC) image signal received from the 2K codec 7a, to the removable medium 11, or reads the 2K (YC) image signal from the removable medium 11. Also, the medium interface 8 writes the 4K (YC) image signal received from the 4K codec 7b, to the removable medium 11, or reads the 4K (YC) image signal from the removable medium 11.

The camcorder 1 includes a view finder 9 and a liquid crystal display 10. The resolutions of images that the view finder 9 and the liquid crystal display 10 can display are much lower than the resolutions of the 4K image and the 2K image. Therefore, it is desirable to convert the resolutions of the 4K image and the 2K image in accordance with the resolutions of the view finder 9 and the liquid crystal display 10.

The camcorder 1 is equipped with a monitor 12 that can output the 4K (YC) image signal or the 2K (YC) image signal to the exterior and display the 4K image or the 2K image. The monitor 12 can display the 4K image whose resolution is not converted, and thereby allows for a check of an actually taken content.

The signal processing circuit 4 includes a compensation unit 21 to compensate the raw data composed of the image signals input from the image sensor 3. The signal processing circuit 4 includes a color separation unit 22 to color-separate an RGB-based s image signal having a first resolution (a 4KRGB-based (4:4:4) image signal (hereinafter, referred to as a “4K (RGB) image signal”)) from the compensated raw data. The signal processing circuit 4 includes a first development unit 23 to write a YC-based s image signal (a 4K (YC) image signal) to a first area (a 4K (YC) area 34a described later) in a memory 34. The YC-based s image signal includes a luminance signal Y and a color signal C that are separated from the RGB-based s image signal. That is, the first development unit 23 according to the exemplary embodiment performs a development processing of the 4K (RGB) image signal, and outputs the 4K (YC) image signal.

The signal processing circuit 4 includes a first resolution conversion unit 24 to convert the RGB-based s image signal into an RGB-based t image signal (a 2KRGB-based (4:4:4) image signal (hereinafter, referred to as a “2K (RGB) image signal”)), which has a resolution different from the RGB-based s image signal. The first resolution conversion unit 24 according to the exemplary embodiment converts the resolution of the 4K (RGB) image signal that the color separation unit 22 outputs, into the resolution of the 2K (RGB) image signal. The signal processing circuit 4 includes a second development unit 25 to write the YC-based t image signal (the 2K (YC) image signal) to a second area (a 2K (YC) area 34b described later) in the memory 34. The YC-based t image signal includes a luminance signal Y and a color signal C that are separated from the RGB-based t image signal. That is, the second development unit 25 according to the exemplary embodiment performs a development processing of the 2K (RGB) image signal, and outputs the 2K (YC) image signal.

The signal processing circuit 4 includes a second resolution conversion unit 26 to convert the resolution of the 2K (YC) image signal to generate an image signal for an image size allowing for a display by the view finder 9 (hereinafter, referred to as a “VF image signal”). Also, the signal processing circuit 4 includes a third resolution conversion unit 27 to convert the resolution of the 2K (YC) image signal to generate an image signal for an image size allowing for a display by the liquid crystal display 10 (hereinafter, referred to as a “LCD image signal”). The second resolution conversion unit 26 or the third resolution conversion unit 27 converts the resolution of the YC-based t image signal, which is read from the second area in the memory 34, into a YC-based u image signal (hereinafter, referred to as a “QHD image signal”), which has a resolution different from the YC-based s image signal and the YC-based t image signal. Then, the YC-based u image signal is written to a third area (a QHD (YC) area 34c described later) in the memory 34.

The signal processing circuit 4 includes a control unit 28 to control a behavior of each unit in the signal processing circuit 4, and an interface unit that is connected to peripheral devices through transmission lines with a predetermined interface standard. The interface unit includes the codec interface 29, a view finder interface 30, a liquid crystal display interface 31, a monitor interface 32 and a memory interface 33, which are described later. The interface unit performs a reading or writing of the YC-based s image signal to the 4K (YC) area 34a or a reading or writing of the YC-based t image signal to the second area, and inputs or outputs the YC-based s image signal or YC-based t image signal to the peripheral devices.

The signal processing circuit 4 includes the codec interface 29 that is an interface with the 2K codec 7a and the 4K codec 7b. The signal processing circuit 4 includes the view finder interface 30 that is an interface with the view finder 9, and the liquid crystal display interface 31 that is an interface with the liquid crystal display 10. The signal processing circuit 4 includes the monitor interface 32 that is an interface with the monitor 12.

The signal processing circuit 4 includes the memory interface 33 that is an interface for inputting and outputting data to the memory 34. To the memory 34, it is possible to save the 4K (YC) image signal, the 2K (YC) image signal, the VF image signal and the LCD image signal. The memory 34 has a maximum bandwidth of about 60 [Gbps], and thereby it is desirable to keep a bandwidth to be used in the memory 34 within 60 [Gbps].

<Flow of an Image Signal Processing when Recording and Displaying an Image>

### [Flow of a Signal Processing by a Method in Related Art]

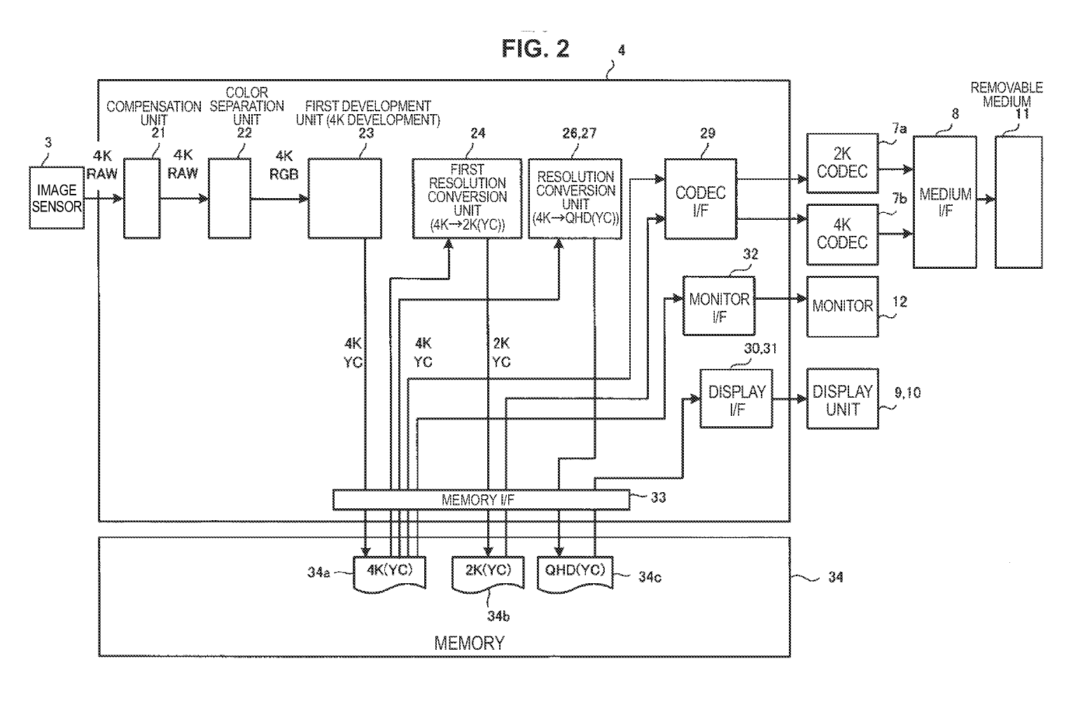

FIG. 2 is a block diagram showing a flow of a signal processing when recoding an image signal and displaying an image by a method in related art. Here is an explanation of a sending and receiving of an image signal between the signal processing circuit 4 and the memory 34.

There is employed a signal processing circuit 4 that has the same configuration as the above-described signal processing circuit 4, except substituting a first resolution conversion unit 24 to convert the 4K (YC) image signal into the 2K (YC) image signal for the first resolution conversion unit 24 to convert the 4K (RGB) image signal into the 2K (RGB) image signal.

When the 4K-based raw data are input from the image sensor 3 to the signal processing circuit 4, the compensation unit 21 compensates the raw data, and the color separation unit 22 color-separates the 4K (RGB) image signal from the compensated raw data. The first development unit 23 performs a processing for developing the 4K (RGB) image signal to the 4K (YC) image signal, and writes the 4K (YC) image signal to the 4K (YC) area 34a in the memory 34.

The first resolution conversion unit 24 converts the 4K (YC) image signal, which is read from the 4K (YC) area 34a, into the 2K (YC) image signal, and writes the 2K (YC) image to the 2K (YC) area 34b in the memory 34. The second resolution conversion unit 26 or third resolution conversion unit 27 (hereinafter, abbreviated to “resolution conversion unit 26, 27”) converts the 4K (YC) image signal, which is read from the 4K (YC) area 34a, into the YC-based QHD image signal, and writes the YC-based QHD image signal to the QHD (YC) area 34c. Here, the QHD (Quarter Full High Definition) means a resolution (960×540) that is a quarter of the full HD resolution (1920×1080). In the following process, the view finder 9 and the liquid crystal display 10 are both dealt with as image displayers with the same QHD resolution.

The codec interface 29 encodes the YC-based s image signal read from the 4K (YC) area 34a or the YC-based t image signal read from the 2K (YC) area 34b, and then outputs the signal to the codec. Also, the codec interface 29 decodes the YC-based s image signal or YC-based t image signal input from the codec, and then writes the signal to the 4K (YC) area 34a. That is, the codec interface 29 sends the 4K (YC) image signal read from the 4K (YC) area 34a, to the 4K codec 7b. Then, the 4K codec 7b writes the encoded 4K (YC) image signal through the medium interface 8 to the removable medium 11. Similarly, the codec interface 29 sends the 2K (YC) image signal read from the 2K (YC) area 34b, to the 2K codec 7a. Then, the 2K codec 7a writes the encoded 2K (YC) image signal through the medium interface 8 to the removable medium 11.

The monitor interface 32 outputs the YC-based s image signal read from the 4K (YC) area 34a or the YC-based t image signal read from the 4K (YC) area 34b, to the monitor 12. That is, the monitor interface 32 outputs the 4K (YC) image signal read from the 4K (YC) area 34a, to the monitor 12.

The view finder interface 30 or the liquid crystal display interface 31 outputs the YC-based u image signal read from the QHD (YC) area 34c, to the view finder 9 or the liquid crystal display 10. That is, the view finder interface 30 or the liquid crystal display interface 31 outputs the YC-based QHD image signal read from the QHD (YC) area 34c, to the view finder 9 or the liquid crystal display 10. In the following description and the drawings, the view finder interface 30 or liquid crystal display interface 31 is abbreviated to “display interface 30, 31”, and the view finder 9 or liquid crystal display 10 is abbreviated to “display unit 9, 10”.

The 4K (YC) image signal is written or read between the signal processing circuit 4 and the memory 34 through the following five signal lines:

(1) a signal line from the first development unit 23 to the 4K (YC) area 34a
(2) a signal line from the 4K (YC) area 34a to the first resolution conversion unit 24
(3) a signal line from the 4K (YC) area 34a to the resolution conversion unit 26, 27 (in the exemplary embodiment, since the display units 9, 10 both have the same image size, this signal line is shown as a single line in the following description)
(4) a signal line from the 4K (YC) area 34a to the codec interface 29
(5) a signal line from the 4K (YC) area 34a to the monitor interface 32

Thereby, if one signal line uses a bandwidth of 12 [Gbps], a bandwidth to be used for the 4K (YC) image signal is 12 [Gbps]×5 [lines]=60 [Gbps].

The 2K (YC) image signal is written or read between the signal processing circuit 4 and the memory 34 through the following two signal lines:

(1) a signal line from the first resolution conversion unit 24 to the 2K (YC) area 34b
(2) a signal line from the 2K (YC) area 34b to the codec interface 29

Thereby, if one signal line uses a bandwidth of 3 [Gbps], a bandwidth to be used for the 2K (YC) image signal is 3 [Gbps]×2 [lines]=6 [Gbps].

The QHD image signal is written or read between the signal processing circuit 4 and the memory 34 through the following two signal lines:

(1) a signal line from the resolution conversion unit 26, 27 to the QHD (YC) area 34c
(2) a signal line from the QHD (YC) area 34c to the display interface 30, 31 (in the exemplary embodiment, since the display units 9, 10 both have the same image size, the signal line to the display interface 30, 31 is shown as a single line in the following description).

Thereby, if one signal line uses a bandwidth of 0.75 [Gbps], a bandwidth to be used for the QHD image signal is 0.75 [Gbps]×2 [lines]=1.5 [Gbps].

From the above, a bandwidth to be used for the image signals between the signal processing circuit 4 and the memory 34 is determined as below.

60+6+1.5=67.5 [Gbps]

The bandwidth to be used exceeds 60 [Gbps], which is the maximum bandwidth of the memory 34. Therefore, in the case of configuring a signal processing flow by the method in related art, it is anticipated that an image signal transfer processing and the like are delayed.

### [Flow of an Image Signal Processing by a Method According to the Exemplary Embodiment]

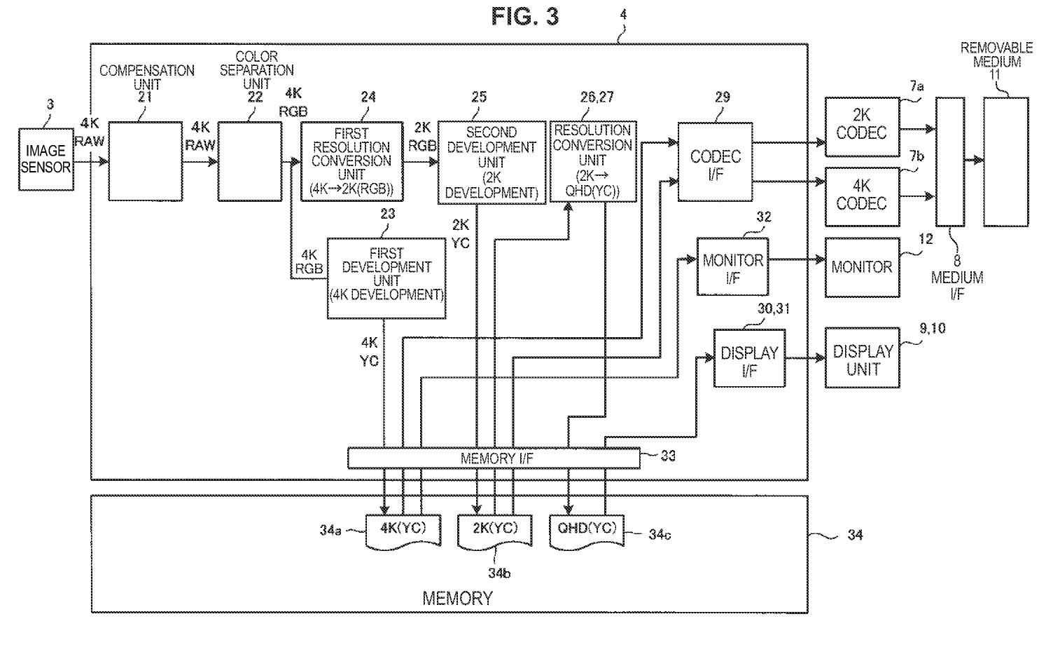

FIG. 3 is a block diagram showing a flow of a signal processing when recoding an image signal and displaying an image by a method according to the exemplary embodiment.

Here is an explanation about how a signal processing is performed for keeping a bandwidth to be used for the image signals within the maximum bandwidth of the memory 34.

When the 4K-based raw data are input from the image sensor 3 to the signal processing circuit 4, the compensation unit 21 compensates the raw data, and the color separation unit 22 color-separates the 4K (RGB) image signal. The first development unit 23 performs a processing for developing the 4K (RGB) image signal to the 4K (YC) image signal, and writes the 4K (YC) image signal to the 4K (YC) area 34a in the memory 34.

The first resolution conversion unit 24 performs a resolution conversion processing for converting the 4K (RGB) image signal into the 2K (RGB) image signal. Then, the second development unit 25 performs a processing for developing the 2K (RGB) image signal received from the first resolution conversion unit 24, to the 2K (YC) image signal, and writes the 2K (YC) image signal to the 2K (YC) area 34b in the memory 34.

The resolution conversion unit 26, 27 converts the 2K (YC) image signal read from the 2K (YC) area 34b, into the YC-based QHD image signal, and writes the YC-based QHD image signal to the QHD (YC) area 34c in the memory 34.

Explanations about subsequent behaviors of the codec interface 29, the 2K codec 7a, the 4K codec 7b, the medium interface 8, the removable medium 11, the monitor interface 32, the monitor 12, the display interface 30, 31, and the display unit 9, 10, are omitted.

The 4K (YC) image signal is written or read between the signal processing circuit 4 and the memory 34 through the following three signal lines:

(1) a signal line from the first development unit 23 to the 4K (YC) area 34a
(2) a signal line from the 4K (YC) area 34a to the codec interface 29
(3) a signal line from the 4K (YC) area 34a to the monitor interface 32

Thereby, if one signal line uses a bandwidth of 12 [Gbps], a bandwidth to be used for the 4K (YC) image signal is 12 [Gbps]×3 [lines]=36 [Gbps].

The 2K (YC) image signal is written or read between the signal processing circuit 4 and the memory 34 through the following three signal lines:

(1) a signal line from the second development unit 25 to the 2K (YC) area 34b
(2) a signal line from the 2K (YC) area 34b to the resolution conversion unit 26, 27
(3) a signal line from the 2K (YC) area 34b to the codec interface 29

Thereby, if one signal line uses a bandwidth of 3 [Gbps], a bandwidth to be used for the 2K (YC) image signal is 3 [Gbps]×3 [lines]=9 [Gbps].

The QHD image signal is written or read between the signal processing circuit 4 and the memory 34 through the following two signal lines:

(1) a signal line from the resolution conversion unit 26, 27 to the QHD (YC) area 34c
(2) a signal line from the QHD (YC) area 34c to the display interface 30, 31

Thereby, if one signal line uses a bandwidth of 0.75 [Gbps], a bandwidth to be used for the QHD image signal is 0.75 [Gbps]×2 [lines]=1.5 [Gbps].

From the above, a bandwidth to be used for the image signals between the signal processing circuit 4 and the memory 34 is determined as below.

36+9+1.5=46.5 [Gbps]

The bandwidth to be used is within 60 [Gbps], which is the maximum bandwidth of the memory 34.

Thus, in the signal processing circuit 4 according to the exemplary embodiment, when displaying a taken through-image or recording the through-image, the down-conversion to the 2K (YC) image signal is not performed after the development processing of the 4K (RGB) image signal. That is, the signal processing circuit 4 executes the development processing of the 4K (RGB) image signal and the development processing of the 2K (RGB) image signal in parallel, without accessing the memory 34. This allows for a reduction in the frequency of access to the 4K (YC) image signal in the memory 34. In addition, there is a merit to allow for a separation between a development setting for the 4K (RGB) image signal and a development setting for the 2K (RGB) image signal, although the circuit size of the signal processing circuit 4 increases accordingly.

### <Flow of an Image Signal Processing at Playing>

[Flow of a Signal Processing by a Method in Related Art]

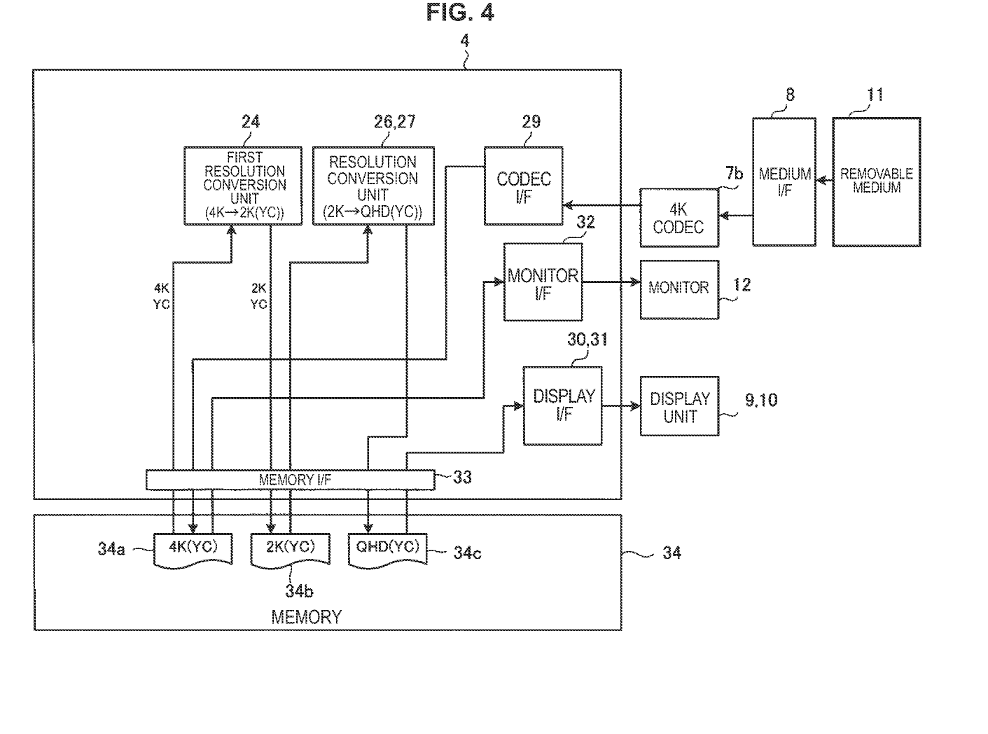

FIG. 4 is a block diagram showing a flow of a signal processing when playing the 4K (YC) image signal by a method in related art.

When playing the 4K (YC) image signal, the medium interface 8 reads the 4K (YC) image signal from the removable medium 11. Then, the 4K (YC) image signal is decoded by the 4K codec 7b, and is written through the codec interface 29 to the 4K (YC) area 34a.

The first resolution conversion unit 24 converts the 4K (YC) image signal read from the 4K (YC) area 34a, into the 2K (YC) image signal, and writes the 2K (YC) image signal to the 2K (YC) area 34b. The resolution conversion unit 26, 27 converts the 2K (YC) image signal read from the 2K (YC) area 34b, into the QHD image signal, and writes the QHD image signal to the QHD (YC) area 34c.

The monitor interface 32 outputs the 4K (YC) image signal read from the 4K (YC) area 34a, to the monitor 12. The display interface 30, 31 outputs the YC-based QHD image signal read from the QHD (YC) area 34c, to the display unit 9, 10.

The 4K (YC) image signal is written or read between the signal processing circuit 4 and the memory 34 through the following three signal lines:

(1) a signal line from the codec interface 29 to the 4K (YC) area 34a
(2) a signal line from the 4K (YC) area 34a to the first resolution conversion unit 24
(3) a signal line from the 4K (YC) area 34a to the monitor interface 32

Thereby, if one signal line uses a bandwidth of 12 [Gbps], a bandwidth to be used for the 4K (YC) image signal is 12 [Gbps]×3 [lines]=36 [Gbps].

The 2K (YC) image signal is written or read between the signal processing circuit 4 and the memory 34 through the following two signal lines:

(1) a signal line from the first resolution conversion unit 24 to the 2K (YC) area 34b
(2) a signal line from the 2K (YC) area 34b to the resolution conversion unit 26, 27

Thereby, if one signal line uses a bandwidth of 3 [Gbps], a bandwidth to be used for the 2K (YC) image signal is 3 [Gbps]×2 [lines]=6 [Gbps].

The QHD image signal is written or read between the signal processing circuit 4 and the memory 34 through the following two signal lines:

(1) a signal line from the resolution conversion unit 26, 27 to the QHD (YC) area 34c
(2) a signal line from the QHD (YC) area 34c to the display interface 30, 31

Thereby, if one signal line uses a bandwidth of 0.75 [Gbps], a bandwidth to be used for the QHD image signal is 0.75 [Gbps]×2 [lines]=1.5 [Gbps].

From the above, a bandwidth to be used for the image signals between the signal processing circuit 4 and the memory 34 is determined as below.

36+6+1.5=43.5 [Gbps]

The bandwidth to be used is within 60 [Gbps], which is the maximum bandwidth of the memory 34.

### [Flow of an Image Signal Processing by a Method According to the Exemplary Embodiment]

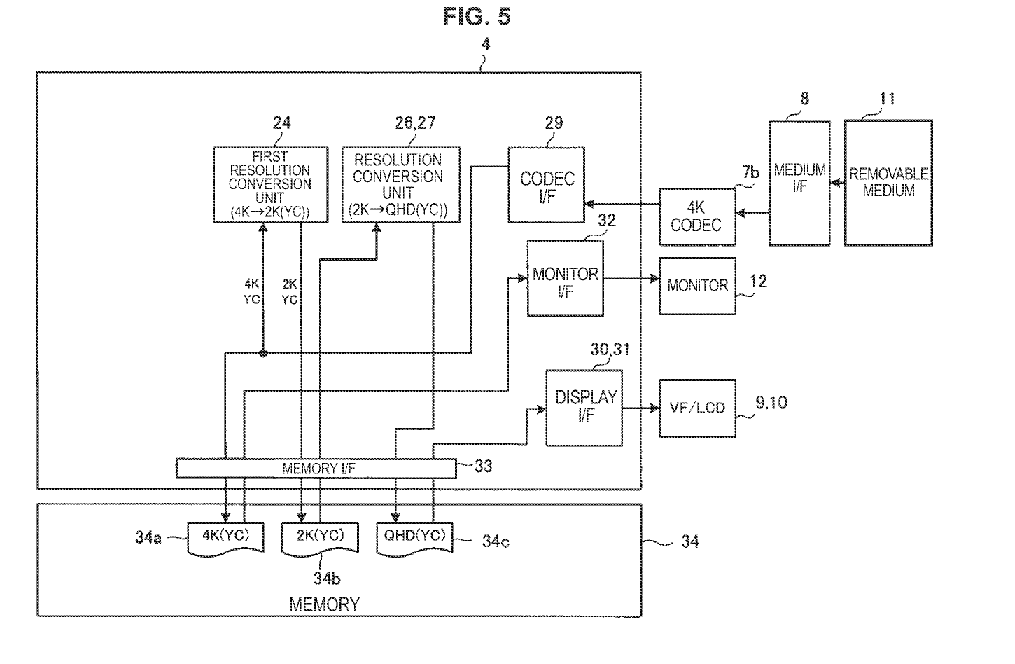

FIG. 5 is a block diagram showing a flow of a signal processing when playing the 4K (YC) image signal by a method according to the exemplary embodiment.

Here is an explanation about how a signal processing is performed for suppressing a bandwidth to be used for the image signals as low as possible.

When playing the YC-based s image signal, the codec interface 29 writes the YC-based s image signal decoded by the codec, to the 4K (YC) area 34a in the memory 34. Then, the first resolution conversion unit 24 converts the YC-based s image signal decoded by the codec, into the YC-based t image signal, and writes the YC-based t image signal to the 2K (YC) area 34b in the memory 34.

Concretely, when playing the 4K (YC) image signal, the medium interface 8 reads the 4K (YC) image signal from the removable medium 11. Then, the 4K (YC) image signal is decoded by the 4K codec 7b, and is written through the codec interface 29 to the 4K (YC) area 34a. Also, the 4K (YC) image signal is output from the codec interface 29 to the first resolution conversion unit 24.

The first resolution conversion unit 24 converts the 4K (YC) image signal input from the codec interface 29, into the 2K (YC) image signal, and writes the 2K (YC) image to the 2K (YC) area 34b. The resolution conversion unit 26, 27 converts the 2K (YC) image signal read from the 4K (YC) area 34b, into the QHD image signal, and writes the QHD image signal to the QHD (YC) area 34c.

The monitor interface 32 outputs the 4K (YC) image signal read from the 4K (YC) area 34a, to the monitor 12. The display interface 30, 31 outputs the YC-based QHD image signal read from the QHD (YC) area 34c, to the display unit 9, 10.

The 4K (YC) image signal is written or read between the signal processing circuit 4 and the memory 34 through the following two signal lines:

(1) a signal line from the codec interface 29 to the 4K (YC) area 34a
(2) a signal line from the 4K (YC) area 34a to the monitor interface 32

Thereby, if one signal line uses a bandwidth of 12 [Gbps], a bandwidth to be used for the 4K (YC) image signal is 12 [Gbps]×2 [lines]=24 [Gbps].

The 2K (YC) image signal is written or read between the signal processing circuit 4 and the memory 34 through the following two signal lines:

(1) a signal line from the first resolution conversion unit 24 to the 2K (YC) area 34b
(2) a signal line from the 2K (YC) area 34b to the resolution conversion unit 26, 27

Thereby, if one signal line uses a bandwidth of 3 [Gbps], a bandwidth to be used for the 2K (YC) image signal is 3 [Gbps]×2 [lines]=6 [Gbps].

The QHD image signal is written or read between the signal processing circuit 4 and the memory 34 through the following two signal lines:

(1) a signal line from the resolution conversion unit 26, 27 to the QHD (YC) area 34c
(2) a signal line from the QHD (YC) area 34c to the display interface 30, 31

Thereby, if one signal line uses a bandwidth of 0.75 [Gbps], a bandwidth to be used for the QHD image signal is 0.75 [Gbps]×2 [lines]=1.5 [Gbps].

From the above, a bandwidth to be used for the image signals between the signal processing circuit 4 and the memory 34 is determined as below.

24+6+1.5=31.5 [Gbps]

The bandwidth to be used is within 60 [Gbps], which is the maximum bandwidth of the memory 34.

When playing the 4K (YC) image signal, also in the method in related art, the bandwidth to be used is within the maximum bandwidth of the memory 34. However, if the bandwidth to be used in the memory 34 can be lowered as much as possible, it is possible to allocate the bandwidth of the memory 34 for another signal processing. Thereby, as shown in the method according to the exemplary embodiment, by directly sending the 4K (YC) image signal from the codec interface 29 to the first resolution conversion unit 24 and then converting this 4K (YC) image signal into the 2K (YC) image signal, it is possible to effectively utilize the bandwidth of the memory 34.

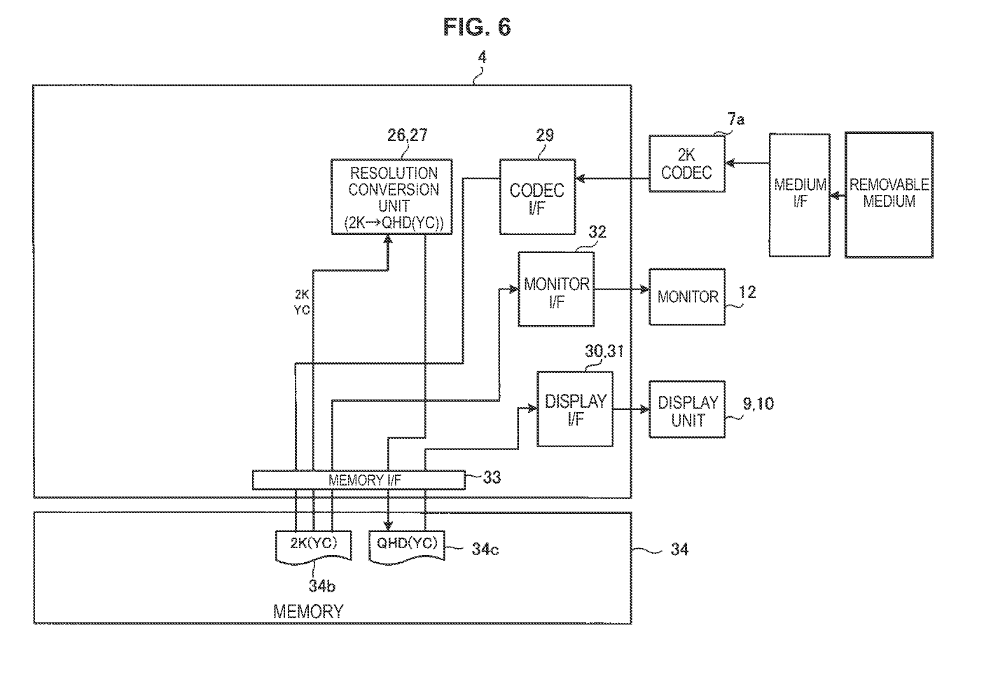

FIG. 6 is a block diagram showing a flow of a signal processing when playing the 2K (YC) image signal by a method according to the exemplary embodiment.

When playing the YC-based t image signal, the codec interface 29 decodes the YC-based t image signal input from the codec, and then writes the YC-based t image signal to the 2K (YC) area 34b in the memory 34. Then, the resolution conversion unit 26, 27 converts the resolution of the YC-based t image signal read from the 2K (YC) area 34b in the memory 34, into the resolution of the YC-based u image signal, and then writes the YC-based u image signal to the QHD (YC) area 34c.

Concretely, when playing the 2K (YC) image signal, the medium interface 8 reads the 2K (YC) image signal from the removable medium 11. Then, the 2K (YC) image signal is decoded by the 2K codec 7a, and is written through the codec interface 29 to the 2K (YC) area 34b. Also, the 2K (YC) image signal is output from the codec interface 29 to the resolution conversion unit 26, 27. The resolution conversion unit 26, 27 converts the 2K (YC) image signal read from the 2K (YC) area 34b, into the QHD image signal, and writes the QHD image signal to the QHD (YC) area 34c.

The monitor interface 32 outputs the 2K (YC) image signal read from the 2K (YC) area 34b, to the monitor 12. The display interface 30, 31 outputs the YC-based QHD image signal read from the QHD (YC) area 34c, to the display unit 9, 10.

The 2K (YC) image signal is written or read between the signal processing circuit 4 and the memory 34 through the following three signal lines:

(1) a signal line from the codec interface 29 to the 2K (YC) area 34b
(2) a signal line from the 2K (YC) area 34b to the resolution conversion unit 26, 27
(3) a signal line from the 2K (YC) area 34b to the monitor interface 32

Thereby, if one signal line uses a bandwidth of 3 [Gbps], a bandwidth to be used for the 2K (YC) image signal is 3 [Gbps]×3 [lines]=9 [Gbps].

The QHD image signal is written or read between the signal processing circuit 4 and the memory 34 through the following two signal lines:

(1) a signal line from the resolution conversion unit 26, 27 to the QHD (YC) area 34c
(2) a signal line from the QHD (YC) area 34c to the display interface 30, 31

Thereby, if one signal line uses a bandwidth of 0.75 [Gbps], a bandwidth to be used for the QHD image signal is 0.75 [Gbps]×2 [lines]=1.5 [Gbps].

From the above, a bandwidth to be used for the image signals between the signal processing circuit 4 and the memory 34 is determined as below.

9+1.5=10.5 [Gbps]

The bandwidth to be used is within 60 [Gbps], which is the maximum bandwidth of the memory 34.

According to the above-described exemplary embodiment, by reducing the frequency of writing and reading of the image signals between the signal processing circuit 4 and the memory 34, it is possible to keep the bandwidth to be used in the memory 34 within the maximum bandwidth of the memory 34. Thereby, the signal processing circuit 4 can access the memory 34 at a high speed and perform a processing.

When displaying the through-image on the display unit 9, 10 or the monitor 12, or when recording the encoded image signal to the removable medium 11, the first development unit 23 and the second development unit 25 operate simultaneously. The first development unit 23 writes the 4K (YC) image signal to the memory 34, and the second development unit 25 writes the 2K (YC) image signal to the memory 34. Thereby, it is possible to reduce the frequency of writing to the memory 34, compared to the processing in related art, in which after the developed 4K (YC) image signal is written to the memory 34, this 4K (YC) image signal is read from the memory 34 and then the 2K (YC) image signal is generated by the resolution conversion.

When reading the image signal from the removable medium 11 and playing the 4K image, the codec interface 29 writes the decoded 4K (YC) image signal to the memory 34. Simultaneously with this writing, the first resolution conversion unit 24 converts the 4K (YC) image signal into the 2K (YC) image signal. Then, the converted 2K (YC) image signal is written to the memory 34. Thereby, also when playing the 4K image, it is possible to reduce the bandwidth to be used in the memory 34 and to allot a function other than a function as a buffer of image signals to the memory 34.

The image size for a display on the display unit 9, 10 is small compared to the 4K image or 2K image. Thereby, by performing the resolution conversion of the 2K (YC) image signal in accordance with the image size of the display unit 9, 10, it is possible to reduce the bandwidth to be used in the memory 34.

The data bandwidth of the baseband of the 4K (YC) image signal is 12 [Gbps], and, performing a writing and reading many times results in a breakdown of the allowable memory bandwidth of the signal processing circuit 4 on one chip. Thereby, it is extremely effective to reduce the frequency of reading and writing to the memory 34.

### 2. Modifications

The 4K (RGB) image signal and the 2K (RGB) image signal can be developed by different types of processing, respectively. For example, it is allowable to develop the 4K (RGB) image signal by gamma correction and develop the 2K (RGB) image signal by S-log. The S-log is a correction processing by which an image with a broad dynamic range, such as reflected light on the waves, is displayed without a breakdown.

In the above-described exemplary embodiment, there is explained an example in which the present disclosure is applied to the camcorder 1 that is an imaging apparatus. Alternatively, the present disclosure may be applied to a playback apparatus in which the optical system 2, the image sensor 3 and the compensation unit 21 are excluded from the camcorder 1.

Note that the series of operations in the foregoing embodiments may be executed in hardware, and may also be executed in software. In the case of executing the series of operations in software, a program constituting such software may be executed by a computer built into special-purpose hardware, or alternatively, by a computer onto which programs for executing various functions are installed. For example, a program constituting the desired software may be installed and executed on a general-purpose personal computer.

Also, a recording medium storing program code of software that realizes the functionality of the foregoing embodiments may also be supplied to a system or apparatus. It is furthermore obvious that the functionality is realized by a computer (or CPU or other control apparatus) in such a system or apparatus retrieving and executing the program code stored in the recording medium.

The recording medium used to supply program code in this case may be a flexible disk, hard disk, optical disc, magneto-optical disc, CD-ROM, CD-R, magnetic tape, non-volatile memory card, or ROM, for example.

Also, the functionality of the foregoing embodiments may realized by a computer executing retrieved program code. In addition, some or all of the actual operations may be conducted on the basis of instructions from such program code by an OS or other software running on the computer. This also encompasses cases where the functionality of the foregoing embodiments is realized by such operations.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)
A signal processing circuit including:

a color separation unit configured to color-separate an RGB-based s image signal from raw data, the RGB-based s image signal having a first resolution;

a first development unit configured to write a YC-based s image signal to a first area in a memory, the YC-based s image signal including a luminance signal Y and a color signal C that are separated from the RGB-based s image signal;

a first resolution conversion unit configured to convert the RGB-based s image signal into an RGB-based t image signal having a resolution different from the RGB-based s image signal;

a second development unit configured to write a YC-based t image signal to a second area in the memory, the YC-based t image signal including a luminance signal Y and a color signal C that are separated from the RGB-based t image signal; and

an interface unit configured to perform a reading or a writing of the YC-based s image signal to the first area, or perform a reading or a writing of the YC-based t image signal to the second area, and to input or output the YC-based s image signal or the YC-based t image signal to a peripheral device, the interface unit being connected to the peripheral device through a transmission line with a predetermined interface standard.

(2)
The signal processing circuit according to (1), further including:

a second resolution conversion unit configured to convert the YC-based t image signal into a YC-based u image signal, and to write the YC-based u image signal to a third area in the memory, the YC-based t image signal being read from the second area in the memory, the YC-based u image signal having a resolution different from the YC-based s image signal and the YC-based t image signal.

(3)
The signal processing circuit according to (1) or (2),

wherein the interface unit includes,

a codec interface configured to encode the YC-based s image signal read from the first area or the YC-based t image signal read from the second area and then output the YC-based s image signal or the YC-based t image signal to a codec, and to decode the YC-based s image signal or the YC-based t image signal input from the codec and then write the YC-based s image signal or the YC-based t image signal to the first area,

a monitor interface configured to output the YC-based s image signal read from the first area or the YC-based t image signal read from the second area, to a monitor, and

a display interface configured to output the YC-based u image signal read from the third area, to a display unit.

(4)
The signal processing circuit according to any one of (1) to (3),

wherein, when the YC-based t image signal is played,

the codec interface decodes the YC-based t image signal input from the codec, and writes the YC-based t image signal to the second area in the memory, and

the second resolution conversion unit converts the YC-based t image signal read from the second area in the memory, into the YC-based u image signal, and writes the YC-based u image signal to the third area in the memory, the YC-based u image signal having a resolution different from the YC-based t image signal.

(5)
The signal processing circuit according to any one of (1) to (3),

wherein, when the YC-based s image signal is played,

the codec interface writes the YC-based s image signal decoded by the codec, to the first area in the memory, and

the first resolution conversion unit converts the YC-based s image signal decoded by the codec, into the YC-based t image signal, and writes the YC-based t image signal to the second area in the memory.

(6)
An imaging apparatus including:

a memory;

an image sensor configured to output raw data based on a subject image formed on an imaging surface through an optical system;

a compensation unit configured to compensate the raw data;

a color separation unit to color-separate an RGB-based s image signal from the compensated raw data, the RGB-based s image signal having a first resolution;

a first development unit configured to write a YC-based s image signal to a first area in the memory, the YC-based s image signal including a luminance signal Y and a color signal C that are separated from the RGB-based s image signal;

a first resolution conversion unit configured to convert the RGB-based s image signal into an RGB-based t image signal having a resolution different from the RGB-based s image signal;

a second development unit configured to write a YC-based t image signal to a second area in the memory, the YC-based t image signal including a luminance signal Y and a color signal C that are separated from the RGB-based t image signal;

an interface unit configured to perform a reading or a writing of the YC-based s image signal to the first area, or perform a reading or a writing of the YC-based t image signal to the second area, and to input or output the YC-based s image signal or the YC-based t image signal to a peripheral device, the interface unit being connected to the peripheral device through a transmission line with a predetermined interface standard; and

a codec configured to encode the YC-based s image signal or the YC-based t image signal input from the interface unit and then output the YC-based s image signal or the YC-based t image signal to a medium, or to decode the YC-based s image signal or the YC-based t image signal input from the medium and then output the YC-based s image signal or the YC-based t image signal to the interface unit.

(7)
A program for causing a computer to execute:

a procedure to color-separate an RGB-based s image signal from raw data, the RGB-based s image signal having a first resolution;

a procedure to write a YC-based s image signal to a first area in a memory, the YC-based s image signal including a luminance signal Y and a color signal C that are separated from the RGB-based s image signal;

a procedure to convert the RGB-based s image signal into an RGB-based t image signal having a resolution different from the RGB-based s image signal;

a procedure to write a YC-based t image signal to a second area in the memory, the YC-based t image signal including a luminance signal Y and a color signal C that are separated from the RGB-based t image signal; and

a procedure to perform a reading or a writing of the YC-based s image signal to the first area, or perform a reading or a writing of the YC-based t image signal to the second area, and to input or output the YC-based s image signal or the YC-based t image signal to a peripheral device, the interface unit being connected to the peripheral device through a transmission line with a predetermined interface standard.

What is claimed is:

1. A signal processing circuit comprising:
a color separation unit configured to color-separate an RGB-based s image signal from raw data, the RGB-based s image signal having a first resolution;
a first development unit configured to write a YC-based s image signal to a first area in a memory, the YC-based s image signal including a luminance signal Y and a color signal C that are separated from the RGB-based s image signal;
a first resolution conversion unit configured to convert the RGB-based s image signal into an RGB-based t image signal having a resolution different from the RGB-based s image signal;
a second development unit configured to write a YC-based t image signal to a second area in the memory, the YC-based t image signal including a luminance signal Y and a color signal C that are separated from the RGB-based t image signal; and
an interface unit configured to perform a reading or a writing of the YC-based s image signal to the first area, or perform a reading or a writing of the YC-based t image signal to the second area, and to input or output the YC-based s image signal or the YC-based t image signal to a peripheral device, the interface unit being connected to the peripheral device through a transmission line with a predetermined interface standard.

2. The signal processing circuit according to claim 1, further comprising:
a second resolution conversion unit configured to convert the YC-based t image signal into a YC-based u image signal, and to write the YC-based u image signal to a third area in the memory, the YC-based t image signal being read from the second area in the memory, the YC-based u image signal having a resolution different from the YC-based s image signal and the YC-based t image signal.

3. The signal processing circuit according to claim 2,
wherein the interface unit includes,
a codec interface configured to encode the YC-based s image signal read from the first area or the YC-based t image signal read from the second area and then output the YC-based s image signal or the YC-based t image signal to a codec, and to decode the YC-based s image signal or the YC-based t image signal input from the codec and then write the YC-based s image signal or the YC-based t image signal to the first area,
a monitor interface configured to output the YC-based s image signal read from the first area or the YC-based t image signal read from the second area, to a monitor, and
a display interface configured to output the YC-based u image signal read from the third area, to a display unit.

4. The signal processing circuit according to claim 3,
wherein, when the YC-based t image signal is played,
the codec interface decodes the YC-based t image signal input from the codec, and writes the YC-based t image signal to the second area in the memory, and
the second resolution conversion unit converts the YC-based t image signal read from the second area in the memory, into the YC-based u image signal, and writes the YC-based u image signal to the third area in the memory, the YC-based u image signal having a resolution different from the YC-based t image signal.

5. The signal processing circuit according to claim 3,
wherein, when the YC-based s image signal is played,
the codec interface writes the YC-based s image signal decoded by the codec, to the first area in the memory, and
the first resolution conversion unit converts the YC-based s image signal decoded by the codec, into the YC-based t image signal, and writes the YC-based t image signal to the second area in the memory.

6. An imaging apparatus comprising:
a memory;
an image sensor configured to output raw data based on a subject image formed on an imaging surface through an optical system;
a compensation unit configured to compensate the raw data;
a color separation unit to color-separate an RGB-based s image signal from the compensated raw data, the RGB-based s image signal having a first resolution;
a first development unit configured to write a YC-based s image signal to a first area in the memory, the YC-based s image signal including a luminance signal Y and a color signal C that are separated from the RGB-based s image signal;
a first resolution conversion unit configured to convert the RGB-based s image signal into an RGB-based t image signal having a resolution different from the RGB-based s image signal;
a second development unit configured to write a YC-based t image signal to a second area in the memory, the YC-based t image signal including a luminance signal Y and a color signal C that are separated from the RGB-based t image signal;
an interface unit configured to perform a reading or a writing of the YC-based s image signal to the first area, or perform a reading or a writing of the YC-based t image signal to the second area, and to input or output the YC-based s image signal or the YC-based t image signal to a peripheral device, the interface unit being connected to the peripheral device through a transmission line with a predetermined interface standard; and
a codec configured to encode the YC-based s image signal or the YC-based t image signal input from the interface unit and then output the YC-based s image signal or the YC-based t image signal to a medium, or to decode the YC-based s image signal or the YC-based t image signal input from the medium and then output the YC-based s image signal or the YC-based t image signal to the interface unit.

7. A program for causing a computer to execute:
a procedure to color-separate an RGB-based s image signal from raw data, the RGB-based s image signal having a first resolution;
a procedure to write a YC-based s image signal to a first area in a memory, the YC-based s image signal including a luminance signal Y and a color signal C that are separated from the RGB-based s image signal;
a procedure to convert the RGB-based s image signal into an RGB-based t image signal having a resolution different from the RGB-based s image signal;
a procedure to write a YC-based t image signal to a second area in the memory, the YC-based t image signal including a luminance signal Y and a color signal C that are separated from the RGB-based t image signal; and
a procedure to perform a reading or a writing of the YC-based s image signal to the first area, or perform a reading or a writing of the YC-based t image signal to the second area, and to input or output the YC-based s image signal or the YC-based t image signal to a peripheral device, the interface unit being connected to the peripheral device through a transmission line with a predetermined interface standard.
